(19) United States
(12) Patent Application Publication
(10) Pub. No.: US 2007/0231422 A1
(43) Pub. Date: Oct. 4, 2007

(54) System to vary dimensions of a thin template

(75) Inventors: Anshuman Cherala, Austin, TX (US); Byung-Jin Choi, Austin, TX (US)

Correspondence Address: MOLECULAR IMPRINTS, PO BOX 81536, AUSTIN, TX, 78708-1536, US

(73) Assignee: MOLECULAR IMPRINTS, INC., Austin, TX (US)

(21) Appl. No.: 11/687,902

(22) Filed: Mar. 19, 2007

Related U.S. Application Data
(60) Provisional application No. 60/788,766, filed on Apr. 3, 2006.

(51) Int. Cl. B28B 7/00

(52) U.S. Cl. 425/453

(57) ABSTRACT

The present invention is directed towards a system to vary dimensions of a body having first and second opposed sides, the first side having a patterning area, the system including, inter alia, a fluid chamber having a support region and a recess, the support region cincturing the recess and the body resting against the support region, with the recess and a portion of the body in superimposition therewith defining a sub-chamber, the sub-chamber having a pressure defined therein to couple the fluid chamber to the second side of the body; and an actuator coupled to the fluid chamber, the actuator applying a force to the fluid chamber such that the dimensions of the body are varied.

### CROSS-REFERENCE TO RELATED APPLICATIONS

The present application claims priority to U.S. Provisional Application No. 60/788,766, filed on Apr. 3, 2006, entitled “Magnification and In-Plane Distortion Correction System and Method for Thin Templates” which is incorporated herein by reference.

### STATEMENT REGARDING FEDERALLY SPONSORED RESEARCH OR DEVELOPMENT

The United States government has a paid-up license in this invention and the right in limited circumstance to require the patent owner to license others on reasonable terms as provided by the terms of 70NANB4H3012 awarded by National Institute of Standards (NIST) ATP Award.

### BACKGROUND INFORMATION

Nano-fabrication involves the fabrication of very small structures, e.g., having features on the order of nanometers or smaller. One area in which nano-fabrication has had a sizeable impact is in the processing of integrated circuits. As the semiconductor processing industry continues to strive for larger production yields while increasing the circuits per unit area formed on a substrate, nano-fabrication becomes increasingly important. Nano-fabrication provides greater process control while allowing increased reduction of the minimum feature dimension of the structures formed. Other areas of development in which nano-fabrication has been employed include biotechnology, optical technology, mechanical systems and the like.

An exemplary nano-fabrication technique is commonly referred to as imprint lithography. Exemplary imprint lithography processes are described in detail in numerous publications, such as United States patent application publication 2004/0065976, filed as U.S. patent application Ser. No. 10/264,960, entitled “Method and a Mold to Arrange Features on a Substrate to Replicate Features having Minimal Dimensional Variability”; United States patent application publication 2004/0065252, filed as U.S. patent application Ser. No. 10/264,926, entitled “Method of Forming a Layer on a Substrate to Facilitate Fabrication of Metrology Standards”; and U.S. Pat. No. 6,936,194, entitled “Functional Patterning Material for Imprint Lithography Processes,” all of which are assigned to the assignee of the present invention.

The imprint lithography technique disclosed in each of the aforementioned United States patent application publications and United States patent includes formation of a relief pattern in a polymerizable layer and transferring a pattern corresponding to the relief pattern into an underlying substrate. The substrate may be positioned upon a stage to obtain a desired position to facilitate patterning thereof To that end, a mold is employed spaced-apart from the substrate with a formable liquid present between the mold and the substrate. The liquid is solidified to form a patterned layer that has a pattern recorded therein that is conforming to a shape of the surface of the mold in contact with the liquid. The mold is then separated from the patterned layer such that the mold and the substrate are spaced-apart. The substrate and the patterned layer are then subjected to processes to transfer, into the substrate, a relief image that corresponds to the pattern in the patterned layer.

### BRIEF DESCRIPTION OF THE DRAWINGS

FIG. 1 is a simplified side view of a lithographic system having a template spaced-apart from a substrate and an actuation system coupled to fluid chambers positioned on the template;

FIG. 2 is a simplified side view of the substrate shown in FIG. 1, having a patterned layer positioned thereon;

FIG. 3 is a simplified side view of the template shown in FIG. 1, the template having a mold positioned thereon having a first width associated therewith;

FIG. 4 is a simplified side view of the mold and the substrate both shown in FIG. 1, the mold having mold alignment marks and the substrate having substrate alignment marks;

FIG. 5 is a simplified top down view of the substrate shown in FIG. 1, the substrate having a plurality of regions;

FIG. 6 is a simplified side view of the template and the mold both shown in FIG. 3, the mold having a second width associated therewith, the second width being less than the first width;

FIG. 7 is a simplified side view of the template and the mold both shown in FIG. 3, the mold having a third width associated therewith, the third width being greater than the first width; and

FIG. 8 is an exploded view of a portion of the template and the mold both shown in FIG. 1, showing a plurality of forces acting upon the template; and

FIG. 9 is a top down view of the template shown in FIG. 1, the template having a plurality of fluid chambers each having an actuator coupled thereto.

### DETAILED DESCRIPTION

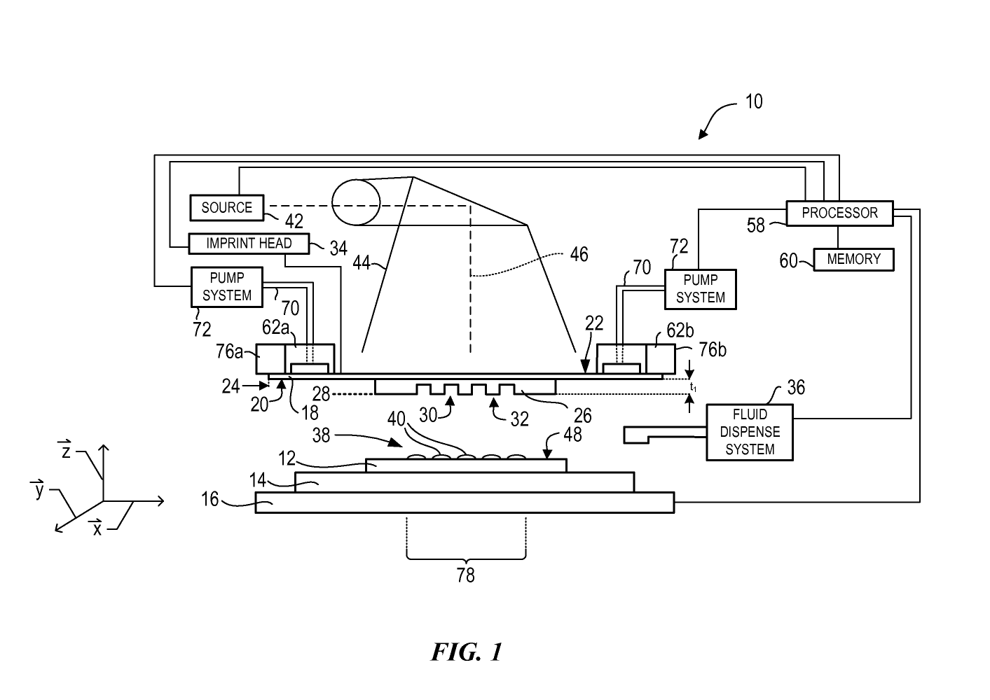

Referring to FIG. 1, a system 10 to form a relief pattern on a substrate 12 is shown. Substrate 12 may be coupled to a substrate chuck 14. Substrate chuck 14 may be any chuck including, but not limited to, vacuum, pin-type, groove-type, or electromagnetic, as described in U.S. Pat. No. 6,873,087 entitled “High-Precision Orientation Alignment and Gap Control Stages for Imprint Lithography Processes,” which is incorporated herein by reference. Substrate 12 and substrate chuck 14 may be supported upon a stage 16. Further, stage 16, substrate 12, and substrate chuck 14 may be positioned on a base (not shown). Stage 16 may provide motion about the x and y axes.

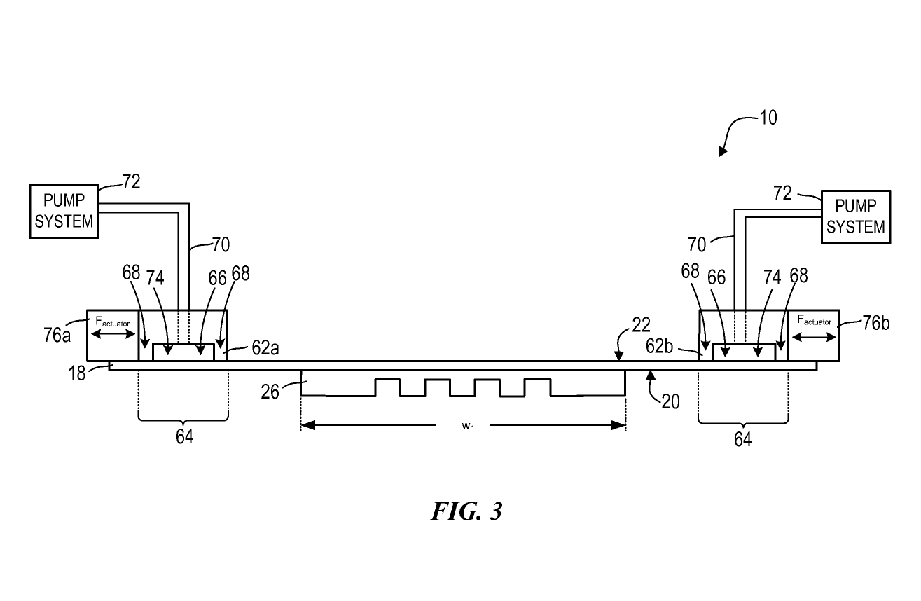

Spaced-apart from substrate 12 is a template 18 having first and second opposed sides 20 and 22. A side, or edge, surface 24 extends between first 20 and second 22 opposed sides. Positioned on first side 20 is a mesa 26 extending from template 18 towards substrate 12 with a patterning surface 28 thereon. Further, mesa 26 may be referred to as a mold 26. Mesa 26 may also be referred to as a nanoimprint mold 26. In an example, template 18 and mold 26 may have a thickness t₁ associated therewith, with thickness t₁ being less than approximately 1.5 mm. In a further embodiment, template 18 may be substantially absent of mold 26. Mold 26 may have a width w₁ associated therewith, shown in FIG. 3. In an example, width w₁ may have a magnitude of 100 mm. Template 18 and/or mold 26 may be formed from such materials including but not limited to, fused-silica, quartz, silicon, organic polymers, siloxane polymers, borosilicate glass, fluorocarbon polymers, metal, and hardened sapphire. As shown, patterning surface 28 comprises features defined by a plurality of spaced-apart recesses 30 and protrusions 32. However, in a further embodiment, patterning surface 28 may be substantially smooth and/or planar. Patterning surface 28 may define an original pattern that forms the basis of a pattern to be formed on substrate 12.

Template 18 may be coupled to a template chuck (not shown), the template chuck (not shown) being any chuck including, but not limited to, vacuum, pin-type, groove-type, or electromagnetic, as described in U.S. Pat. No. 6,873,087 entitled “High-Precision Orientation Alignment and Gap Control Stages for Imprint Lithography Processes.” Template 18 may be coupled to an imprint head 34 to facilitate movement of template 18 and mold 26. In a further embodiment, the template chuck (not shown) may be coupled to imprint head 34 to facilitate movement of template 18 and mold 26.

System 10 further comprises a fluid dispense system 36. Fluid dispense system 36 may be in fluid communication with substrate 12 so as to deposit polymeric material 38 thereon. System 10 may comprise any number of fluid dispensers and fluid dispense system 36 may comprise a plurality of dispensing units therein. Polymeric material 38 may be positioned upon substrate 12 using any known technique, e.g., drop dispense, spin-coating, dip coating, chemical vapor deposition (CVD), physical vapor deposition (PVD), thin film deposition, thick film deposition, and the like. As shown, polymeric material 38 may be deposited upon substrate 12 as a plurality of spaced-apart droplets 40. Typically, polymeric material 38 is disposed upon substrate 12 before the desired volume is defined between mold 26 and substrate 12. However, polymeric material 38 may fill the volume after the desired volume has been obtained.

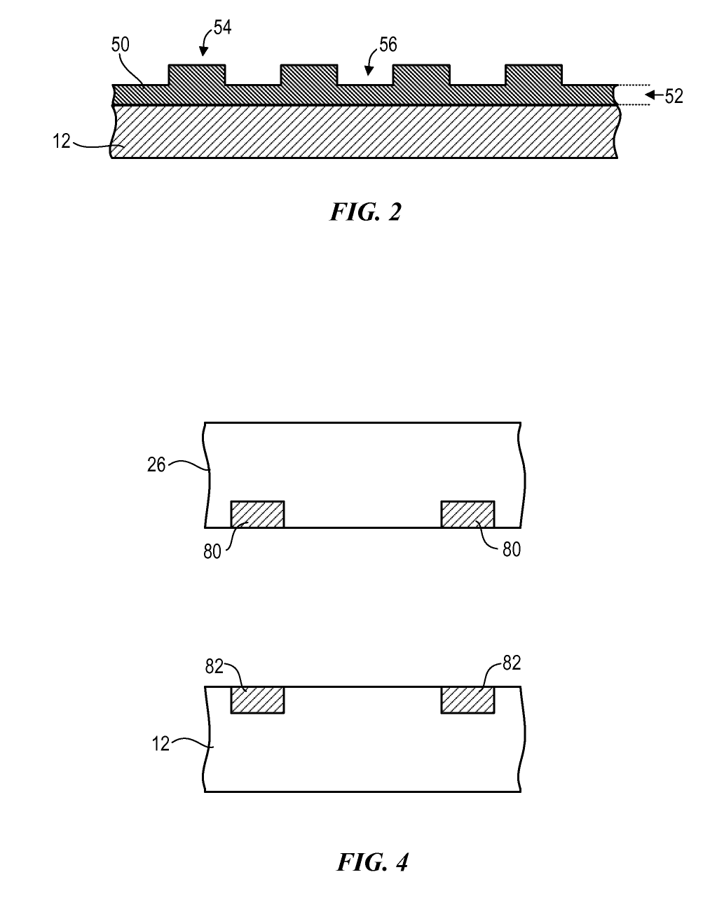

Referring to FIGS. 1 and 2, system 10 further comprises a source 42 of energy 44 coupled to direct energy 44 along a path 46. Imprint head 34 and stage 16 are configured to arrange mold 26 and substrate 12, respectively, to be in superimposition and disposed in path 46. Either imprint head 34, stage 16, or both vary a distance between mold 26 and substrate 12 to define a desired volume therebetween that is filled by polymeric material 38. More specifically, droplets 40 may ingress and fill recesses 30. After the desired volume is filled with polymeric material 38, source 42 produces energy 44, e.g., broadband ultraviolet radiation that causes polymeric material 38 to solidify and/or cross-link conforming to the shape of a surface 48 of substrate 12 and patterning surface 28, defining a patterned layer 50 on substrate 12. Patterned layer 50 may comprise a residual layer 52 and a plurality of features shown as protrusions 54 and recessions 56. System 10 may be regulated by a processor 58 that is in data communication with stage 16, imprint head 34, fluid dispense system 36, and source 42, operating on a computer readable program stored in memory 60.

Referring to FIGS. 1 and 3, system 10 further comprises fluid chambers 62 positioned on second side 22 of template 18. As shown, system 10 comprises first and second fluid chambers 62a and 62b; however, in a further embodiment, system 10 may comprise any number of fluid chambers 62, described further below. Fluid chambers 62 may be in superimposition with a region 64 of template 18. Each of fluid chambers 52 comprises a recess 66 and a support region 68 with support region 68 cincturing recess 66. Formed in each of fluid chambers 62 are throughways 70 to place each of fluid chamber 62 in fluid communication with a pump system 72. Pump system 72 may include one or more pumps therein. In a further embodiment, system 10 may comprise any number of throughways 70 and any number of pump systems 72. For simplicity of illustration, pump system 72 is shown as two separate bodies. Pump system 72 may be in data communication with processor 58, operating on a computer readable program stored in memory 60 to control pump system 72. Furthermore, recess 66 of fluid chambers 62 and a portion of template 18 in superimposition therewith define a sub-chamber 74. Pump system 72 operates to control a vacuum within sub-chamber 74 such that fluid chambers 62 are coupled to second side 22 of template 18.

System 10 further comprises actuators 76 coupled to fluid chambers 62. As shown, system 10 comprises first and second actuators 76a and 76b coupled to fluid chambers 62a and 62b, respectively; however, in a further embodiment system 10 may comprise any number of actuators 76. Actuators 76 may be any force or displacement actuator known in the art including, inter alia, pneumatic, piezoelectric, magnetostrictive, and voice coils. Actuators 76 apply a force F_{actuator} to fluid chambers 62 to vary a dimension of template 18, described further below. Force F_{actuator} may be a compressive or a stretching force.

To that end, it may be desired that mold 26 have dimensions commensurate with the dimensions of a region of substrate 12 upon which the pattern is to be formed, i.e. a region 78 of substrate 12 upon which polymeric material 38 is positioned/patterned layer 50, shown in FIG. 2, is formed to minimize, if not prevent, distortions in patterned layer 50, shown in FIG. 2. These dimensional variations, which may be due in part to thermal fluctuations, as well as, inaccuracies in previous processing steps, produce what is commonly referred to as magnification/distortion errors. The magnification/distortion errors occur when region 78 of substrate 12 in which the original pattern is to be recorded exceeds the area of the original pattern. Additionally, magnification/distortion errors may occur when region 78 of substrate 12, in which the original pattern is to be recorded, has an area smaller than the original pattern. The deleterious effects of magnification/distortion errors are exacerbated when forming multiple layers of imprinted patterns. Proper alignment between two superimposed patterns is difficult in the face of magnification/distortion errors in both single-step full wafer imprinting and step-and-repeat imprinting processes.

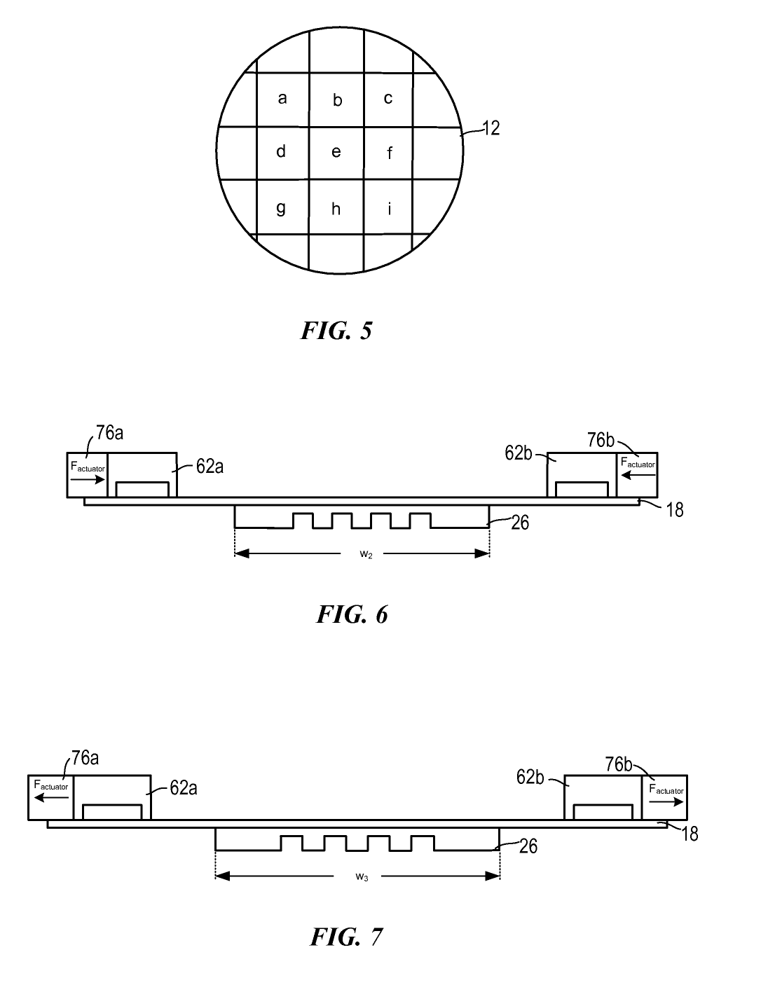

Referring to FIGS. 1 and 4, to that end, to properly form patterned layer 50, shown in FIG. 2, in the method mentioned above, alignment between mold 26 and substrate 12 may be desired. To that end, mold 26 comprises mold alignment marks 80 and substrate 12 comprises substrate alignment marks 82. In a further embodiment, substrate 12 may comprise a plurality of regions, shown as regions a-i in FIG. 5, with one or more regions a-i of substrate 12 comprising substrate alignment marks 82. In still a further embodiment, template 18 may comprise template alignment marks (not shown), employed in substantially the same manner as mold alignment marks 80.

To that end, by ensuring that mold alignment marks 80 are properly aligned with substrate alignment marks 82, proper alignment between mold 26 and substrate 12 may be obtained. To that end, machine vision devices (not shown) may be employed to determine an alignment between mold alignment marks 80 and substrate alignment marks 82. In the present example, alignment between mold 26 and substrate 12 occurs upon mold alignment marks 80 and substrate alignment marks 82 being in superimposition. With the introduction of magnification/distortion errors, alignment between mold 26 and substrate 12 becomes difficult.

However, in accordance with one embodiment of the present invention, magnification/distortion errors may be minimized, if not prevented, by creating relative dimensional variations between mold 26 and substrate 12. In this manner, the area of the original pattern is made coextensive with the area of region 78 of substrate 12 in superimposition therewith. The present invention attenuates, if not abrogates, magnification/distortion errors by providing control of the relative dimensions between the original pattern and region 78 of substrate 12 upon which the original pattern is to be recorded. Specifically, the present invention allows control of the dimensional relationship between the original pattern present in mold 26 and the recorded pattern formed substrate 12. In this manner, the size of the recorded patterned may appear to be magnified and/or reduced, when compared to the original pattern. This may be achieved so that the sizes of the original pattern and the recorded pattern are substantially equal.

Referring to FIGS. 1 and 3, to that end, controlling the relative dimensions between the original pattern and the recorded pattern is provided by altering a shape of template 18/mold 26. However, as mentioned above, template 18/mold 26 has a thickness t₁ associated therewith. Thickness t₁ may have a magnitude such that altering template 18/mold 26 by application of a force to side surface 24 may result in, inter alia, buckling of template 18/mold 26, which may be undesirable. To that end, as mentioned above, fluid chambers 62 are coupled to second side 22 of template 18 by pump system 72 via throughways 70. As a result, upon application of the force F_{actuator} by actuators 76 upon fluid chambers 62, a shape of template 18/mold 26 may be altered, as desired, described further below.

Referring to FIG. 3 and 6, more specifically, in a first example, it may be desired to reduce the recorded pattern of mold 26 when compared to the original pattern of mold 26. To that end, actuators 76 may exert the force F_{actuator} in a direction towards fluid chamber 62. As a result of fluid chamber 62 being coupled to template 18, a shape of template 18/mold 26 is compressed. More specifically, the shape of mold 26 is compressed such that the width w₁ of mold 26 is decreased to a width w₂, with width w₂ being less than width w₁. In an example, width w₂ may have a magnitude of 99.9995 mm. As a result, the recorded pattern would be compressed when compared with the original pattern of mold 26, as desired.

Referring to FIG. 3 and 7, in a second example, it may be desired to magnify the recorded pattern of mold 26 when compared to the original pattern of mold 26. To that end, actuators 76 may exert the force F_{actuator} in a direction away from fluid chamber 62. As a result of fluid chamber 62 being coupled to template 18, a shape of template 18/mold 26 is magnified. More specifically, the shape of mold 26 is magnified such that the width w₁ of mold 26 is increased to a width w₃, with width w₃ being greater than width w₁. In an example, width w₃ may have a magnitude of 100.0005 mm. As a result, the recorded pattern would be magnified when compared with the original pattern of mold 26, as desired.

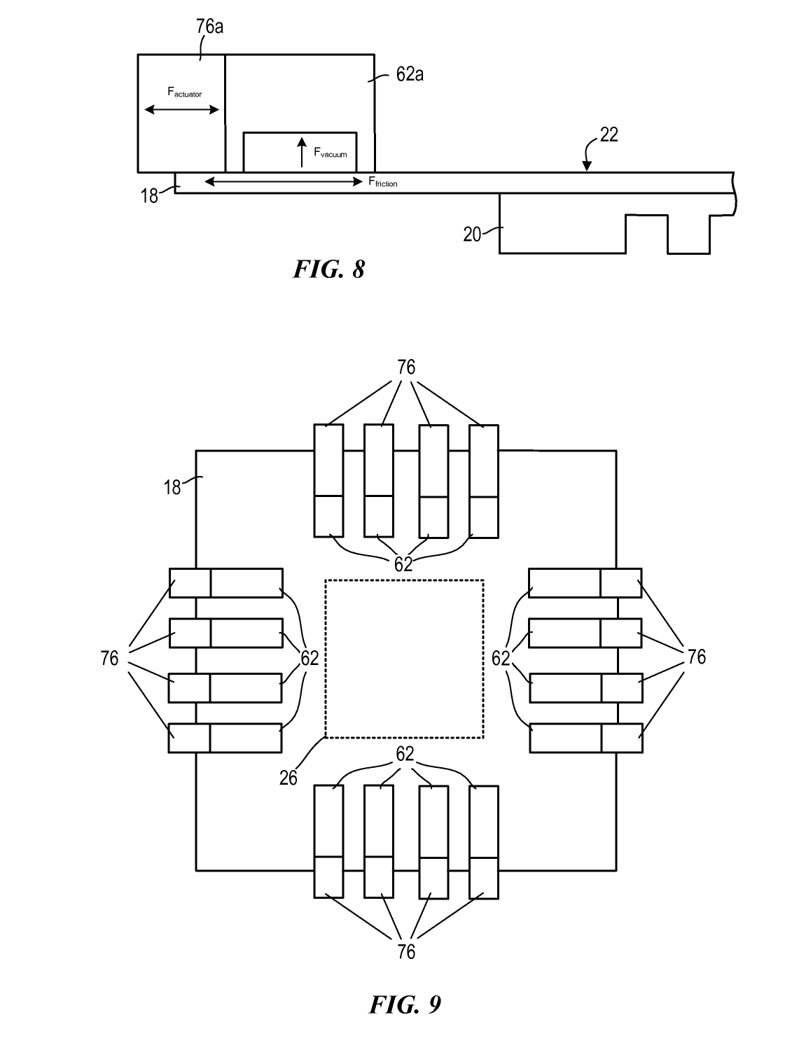

Referring to FIGS. 1, 3, and 8, furthermore, during application of force F_{actuator} by actuators 76 upon fluid chambers 62, a magnitude of force F_{actuator} may result in translation of fluid chambers 62 such that fluid chambers 62 are not in superimposition with portion 64 of template 18, which is undesirable. To that end, to ensure fluid chambers 62 remain in superimposition with portion 64 of template 18 during application of force F_{actuator}, force F_{actuator} may be less than or equal to a maximum frictional force F_{friction} generated between fluid chambers 62 and second side 22 of template 18, i.e.:

F_{actuator}≦F_{friction}. (1)

To that end, F_{friction} may be defined as follows:

F_{friction}=μ×F_{vacuum} (2)

where μ is the coefficient of static friction between fluid chamber 62 and second side 22 of template 18 and F_{vacuum} is the force exerted upon portion 64 of template 18 by fluid chambers 62 as a result of the vacuum defined within sub-chamber 74, described above. To that end, the force F_{vacuum} may be defined as follows:

F_{vacuum}=A_{recess}×P_{sub-chamber} (3)

where A_{recess} is the area of recess 66 of fluid chamber 62 and P_{sub-chamber} is the pressure associated with sub-chamber 74. Thus, employing equations (2) and (3) with equation (1), the force F_{actuator} may be defined as follows:

F_{actuator}≦μ×A_{recess}×P_{sub-chamber} (4)

However, the force F_{actuator} has a magnitude associated therewith such that upon application of force F_{actuator} by actuators 76 upon fluid chambers 62, a shape of template 18/mold 26 may be altered, wherein the magnitude of force F_{actuator} is a function of thickness t₁ of template 18/mold 26. The magnitude of force F_{actuator} necessary to alter template 18/mold 26 may be determined employing Finite Element Analysis and optimization algorithms. To that end, the area A_{recess} of recess 66 of fluid chamber 62 and the pressure P_{sub-chamber} associated with sub-chambers 74 may be varied such that force F_{actuator} may have a magnitude to alter a shape of template 18/mold 26 while the force F_{actuator} is less than the force F_{friction} such that fluid chambers 62 remains in superimposition with region 64 of template 18.

Referring to FIG. 9, as mentioned above, the shape of template 18/mold 26 may be altered along a first direction. However, in a further embodiment, the shape of template 18/mold 26 may be altered concurrently in first and second directions, with the second direction extending orthogonal to the first direction. In an example, template 18/mold 26 may be altered along the x and y directions. To that end, template 18 is shown having a plurality of fluid chambers 62 coupled thereto. As shown, template 18 comprises four fluid chambers 62 on each side of template 18, resulting in sixteen fluid chambers 62. However, template 18 may have any number of fluid chambers 62 coupled thereto and may have differing number of fluid chambers 62 coupled to each side of template 18. Template 18 may have any configuration and number of fluid chambers positioned on second side 22 thereof to facilitate altering a shape of template 18/mold 26. As a result of having a plurality of fluid chambers 62 positioned upon multiple sides of template 18, with each fluid chamber 62 have an actuator 76 coupled thereto, template 18 may be altered in the first and second directions.

In a further embodiment, the above-mentioned system and method may further be employed during altering a shape of template 18/mold 26 when mold 26 is in contact with polymeric material 38. More specifically, a capillary force may be present between polymeric material 38, substrate 12, and mold 26, as described in United States patent application publication 2005/0061773 entitled “Capillary Imprinting Technique,” which is incorporated herein by reference. As a result, translation of template 18/mold 26 in a direction normal to a plane in which template 18/mold 26 lies in and translation of substrate 12 in a direction normal to a plane in which substrate 12 lies in may be limited, while magnification/reduction of template 18/mold 26 may be facilitated. As a result, the above-mentioned system and method may further be employed during altering a shape of template 18/mold 26 when mold 26 is in contact with polymeric material 38.

Furthermore, as a result of positioning fluid chambers 62 and actuators 76 on a second side 22 of template 18, contact between fluid chambers 62/actuators 76 and substrate 12 is minimized, if not prevented. Contact between fluid chambers 62/actuators 76 and substrate 12 may result in, inter alia, structural compromise of system 10, impedance of contact between mold 26 and polymeric material 38, misalignment of mold 26 with respect to substrate 12, and damage to substrate 12 and/or mold 26, all of which are undesirable.

Referring to FIG. 1, in still a further embodiment, the above-mentioned method of altering a shape of template 18/mold 26 may be analogously applied to substrate 12. In still a further embodiment, substrate 12 may be altered employing a plurality of actuators in lieu of, or in combination with, altering a shape of template 18/mold 26.

The embodiments of the present invention described above are exemplary. Many changes and modifications may be made to the disclosure recited above, while remaining within the scope of the invention. Therefore, the scope of the invention should not be limited by the above description, but instead should be determined with reference to the appended claims along with their full scope of equivalents.

What is claimed is:

1. A nanoimprint lithography system to vary dimensions of a body having first and second opposed sides, said first side having a patterning area, said system comprising:
a fluid chamber having a support region and a recess, said support region cincturing said recess and said body resting against said support region, with said recess and a portion of said body in superimposition therewith defining a sub-chamber, said sub-chamber having a pressure defined therein to couple said fluid chamber to said second side of said body; and
an actuator coupled to said fluid chamber, said actuator applying a force to said fluid chamber such that said dimensions of said body are varied.

2. The system as recited in claim 1 further including a pump system in fluid communication with said sub-chamber to control said pressure therein.

3. The system as recited in claim 2 further including a throughway to place said pump system in fluid communication with said sub-chamber

4. The system as recited in claim 1 wherein said fluid chamber further comprises a plurality of sub-chambers.

5. The system as recited in claim 1 wherein said force of said actuator further comprises a compressive force, with said compressive force being applied to at least a portion of said body.

6. The system as recited in claim 1 wherein said force of said actuator further comprises a stretching force, with said stretching force being applied to at least a portion of said body.

7. The system as recited in claim 1 further including a plurality of actuators coupled to a plurality of fluid chambers to apply said force to said body to vary said dimensions.

8. A nanoimprint lithography system to vary dimensions of a body having first and second opposed sides, said first side having a patterning area, said system comprising:
a fluid chamber having a support region and a recess, said support region cincturing said recess and said body resting against said support region, with said recess and a portion of said body in superimposition therewith defining a sub-chamber, said sub-chamber having a pressure therein to couple said fluid chamber to said second side of said body; and
an actuator coupled to said fluid chamber, said actuator exerting a force on said fluid chamber such that said dimensions of said body are varied while minimizing translation of said fluid chamber with respect to said body.

9. The system as recited in claim 8 further including a pump system in fluid communication with said sub-chamber to control said pressure therein.

10. The system as recited in claim 9 further including a throughway to place said pump system in fluid communication with said sub-chamber

11. The system as recited in claim 8 wherein said fluid chamber further comprises a plurality of sub-chambers.

12. The system as recited in claim 8 wherein said force of said actuator further comprises a compressive force, with said compressive force being applied to at least a portion of said body.

13. The system as recited in claim 8 wherein said force of said actuator further comprises a stretching force, with said stretching force being applied to at least a portion of said body.

14. The system as recited in claim 8 further including a plurality of actuators coupled to a plurality of fluid chambers to apply said force to said body to vary said dimensions.

15. A nanoimprint lithography system to vary dimensions of a body having first and second opposed sides, said first side having a patterning area, said system comprising:
a fluid chamber having a support region and a recess, said support region cincturing said recess and said body resting against said support region, with said recess and a portion of said body in superimposition therewith defining a sub-chamber, said sub-chamber having a pressure defined therein to couple said fluid chamber to said second side of said substrate; and
an actuator coupled to said fluid chamber, said actuator applying an actuation force to said fluid chamber such that said dimensions of said body are varied, with said actuation force being less than a frictional force defined between said fluid chamber and said second side of said body.

16. The system as recited in claim 15 further including a pump system in fluid communication with said sub-chamber to control said pressure therein.

17. The system as recited in claim 16 further including a throughway to place said pump system in fluid communication with said sub-chamber

18. The system as recited in claim 15 wherein said fluid chamber further comprises a plurality of sub-chambers.

19. The system as recited in claim 15 wherein said force of said actuator further comprises a compressive force, with said compressive force being applied to at least a portion of said body.

20. The system as recited in claim 15 wherein said force of said actuator further comprises a stretching force, with said stretching force being applied to at least a portion of said body.

21. The system as recited in claim 15 further including a plurality of actuators coupled to a plurality of fluid chambers to apply said force to said body to vary said dimensions.
